(19) United States
(12) Patent Application Publication
(10) Pub. No.: US 2026/0259078 A1
(43) Pub. Date: Sep. 3, 2026

(54) METHOD AND DEVICE FOR DETERMINING A LEVEL OF NOISE AND ELECTROMAGNETIC VIBRATIONS

(71) Applicant: Dassault Systèmes Americas Corp., Waltham, MA (US)

(72) Inventors: Jean LE BESNERAIS, Sailly lez Lannoy (FR); Emilie DEVILLERS, Marseille (FR); Pierre BONNEEL, Lesquin (FR); Raphaël PILE, Lambersart (FR)

(73) Assignee: Dassault Systèmes Americas Corp., Waltham, MA (US)

(21) Appl. No.: 19/490,009

(22) PCT Filed: Jun. 6, 2023
(86) PCT No.: PCT/EP2023/065144

§ 371 Date: Dec. 4, 2025

(51) Int. Cl. G01H 11/02

(52) U.S. Cl. CPC G01H 11/02

(57) ABSTRACT

A method and device for determining a level of noise and electromagnetic vibrations in a machine with an electric motor. To this end, a computer device obtains (31, 32) a set of loading cases and eigenmodes of the machine, determines (33) a significant subset, obtains (34) a set of relevant nodes and calculates (35) a set of frequency response functions restricted to the relevant nodes, obtains (36, 37) a set of operating points and magnetic states of the machine, determines (38) a set of operational loads of the machine, then determines (39) a level of noise and electromagnetic vibrations on the basis of the frequency response functions and the operational loads.

### CROSS-REFERENCE TO RELATED APPLICATIONS

This application is a 371 National Phase of PCT/EP2023/065144, filed Jun. 6, 2023, which is incorporated herein by reference as if fully set forth.

### TECHNICAL FIELD

The present invention relates to the virtual prototyping of electrical systems emitting acoustic noise of electromagnetic origin.

The present invention relates more particularly to a method for determining a noise and vibration level of electromagnetic origin of a machine comprising an electric motor.

The present invention also relates to a device implementing such a method.

The present invention additionally relates to designing machines with an electric motor, implementing such a method.

The invention will thus find many advantageous applications in designing electrical machines involved in sectors such as transportation (automobile, railway, maritime), industry, energy, medical and domestic applications.

### PRIOR ART

All mechanical systems produce noise. Very often, resonance phenomena between modes of structure and excitation forces are the main cause or contribute greatly to the problem of noise and vibrations. At the origin of these resonance phenomena is a specific component of the system, or else the whole of the system or of the structure.

These noise and vibration phenomena occur in machines in operation, in particular during the rotational movement for the rotating machines. A high noise or vibration level can result in a loss of acoustic comfort or in loss of manual comfort, or even health problems in the event of prolonged exposure to noise, and is also a generator of breakdowns and breakages by fatigue of the physical structure of the system.

In the simplest cases, the origin of the resonant vibrations can be identified empirically (e.g: problem of clamping mechanical parts), or the noise can be limited by adapting the structure of the system adequately (e.g: adding acoustic cowling). This origin quickly becomes more complex to identify in the case of noise of electromagnetic origin because of the complexity of the excitation forces involved.

The Applicant observes that the solutions proposed to date for predicting the vibrations of magnetic origin of a given machine are based on a numerical simulation coupling different finite element software for generic use in the fields of low-frequency electromagnetism, of the dynamics of the structures and of the linear acoustics These solutions thus provide, in a first step, an exhaustive calculation of the magnetic forces at variable speed, in a second step a calculation of the vibrations by modal expansion, and in a third step an evaluation of an acoustic radiation around the machine These solutions make it possible to obtain precise results on the level of vibrations generated by a given machine, but require a very high calculation time, of the order of 15 hours per machine. Such an approach is thus incompatible with the design phases of electrical machines, since each iteration or design change requires a time-consuming simulation in order to estimate its electromagnetic noise. The Applicant also submits that other complementary approaches have been developed, based on the approximate calculation of the magnetic forces or on the electromagnetic vibratory synthesis, and making it possible to use the linearity of the structures to accelerate the calculation times. These can thus be reduced to about 1, 5 h in the simplest cases.

However, the Applicant submits that these calculations remain heavy, take place in consequent memory, and become heavier even in the case of complex loadings, for example in the case of a machine with a skewed rotor. Furthermore, these solutions make it possible to obtain only a final estimate of the total noise generated by the machine. It is therefore difficult to identify how to reduce the noise, and improve the design of the machine requires multiplying the simulations in order to find a solution-minimizing noise.

The Applicant submits that the current solutions have very long calculation times incompatible with an iterative design approach, a large memory size both during calculations (on the RAM) and at the output of the calculation (on the hard disk), a vulnerability to numerical noise in the results due to mesh projections, digital interpolations and spectral spreading, and do not provide information or differentiation on the origin of the noise and vibrations of magnetic origin.

The Applicant therefore submits that the solutions for determining a noise and vibration level of electromagnetic origin are not satisfactory and in particular unsuitable for industrial design and prototyping needs.

### SUMMARY

The present invention aims to improve the situation described above.

The present invention aims in particular to remedy the above drawbacks by proposing a method and a device for determining noise of magnetic origin making it possible to integrate such a determination within the design phases, so as to provide a simplified and assistant tool for designing machines with an electric motor, without slowing it down. According to a first aspect, the subject matter of the present invention relates to a method for determining a noise and vibration level of electromagnetic origin of an electric motor machine having a mechanical structure, said machine comprising a rotor and a stator, said rotor and said stator being separated from an air gap, the method being implemented by at least one processor, the method comprising the following steps:
obtaining a first data representative of a set of loading cases associated with the machine, each loading case corresponding to a component of a magnetic loading according to a decomposition on a mathematical basis, preferably Fourier series;
obtaining second data representative of a set of eigenmodes of the mechanical structure;
determining, from the set of loading cases and the set of eigenmodes, a subset of cases of loading and of significant eigenmodes;
obtaining third data representative of a set of relevant nodes associated with the mechanical structure;
computing a set of frequency response functions, by modal expansion restricted to the set of relevant nodes and to the subset of loading cases and significant eigenmodes;
obtaining fourth data representative of a first set of operating points of the machine, each operating point being associated with a torque and a speed of the machine;
obtaining fifth data representative of a set of magnetic states of the machine, each magnetic state of the set of magnetic states being associated with an operating point;
determining a set of operational loadings from the set of magnetic states; and
determining information representative of a noise and vibration level of electromagnetic origin of the machine from the set of operational loadings and from the set of frequency response functions.

It is understood here that the loading cases correspond to the components of the forces applied to the electric machine, in particular at different points of the rotor and of the stator. The magnetic loadings of the electric machine are for example defined on the basis of design parameters of the electric machine, i.e. that they follow the structure of the magnetic circuit of the electric machine. The loading cases are associated with an arbitrarily fixed amplitude or operational level, for example a unit loading, that is to say associated with an amplitude of 1N to simplify the calculations.

Each loading case comprises, for example, all of the following information:
a type of loading: force or torque;
an application direction, for example for a force: radial, circumferential,
an application structure: rotor or stator; and
a wavenumber: r=0, 1, 2, etc.

According to a particular embodiment, the set of loading cases is restricted to the lowest wavenumbers existing in the machine, for example only the excitations of wavenumber r=0. The person skilled in the art understands that the lowest wavenumbers are associated with the most important excitations, this restriction can thus limit unnecessary calculations without impacting the accuracy of the results.

It is further understood that the set of eigenmodes corresponds to a representation of the harmonic vibratory behavior of the machine in an appropriate manner to a vibratory analysis. Each eigenmode is for example characterized by a modal deformation, a natural frequency and a modal damping. It will be understood by those skilled in the art that any response to an excitation will correspond to a unique linear combination of the eigenmodes. The determination of the subset of loading cases and of significant eigenmodes corresponds to an identification of the combinations between the loading cases and eigenmodes resulting in significant vibrations. In other words, this determination makes it possible, for each loading case, to identify the mode(s) the shape of which is closest to the loading case. This design thus makes it possible to reduce the set of loading cases and the set of eigenmodes of the elements contributing significantly to the noise of electromagnetic origin, and therefore to avoid superfluous calculations.

It is also understood that the set of relevant nodes corresponds to a reduction, with respect to all the nodes resulting from a mesh of the structure of the machine, to the nodes relevant to the calculation. These nodes may be relevant for the visualization of the modes of interest, for carrying out the calculation, or for the verification of design criteria, for example vibratory standards. The relevant nodes are for example reduced at the tooth heads of the electric motor where the majority of the magnetic forces apply, to the fixing points of the machine where vibratory design criteria apply, and to the envelope points of the structure whose normal vibration is responsible for the acoustic radiation. The modal deformations of the eigenmodes of the subset determined above are reduced to this set of relevant nodes, that is to say that the modal deformations are calculated, during the calculation of the set of frequency response functions, only for the set of relevant nodes.

A person skilled in the art understands that the set of frequency response functions makes it possible to obtain, for each node of the set of relevant nodes, for example the amplitude of the vibrations or an acoustic pressure amplitude under the effect of the loading cases applied to the eigenmodes.

The principle of modal expansion is known from the prior art and represents a considerable source of the calculation time, in particular at high frequencies where the modal density is greater, its restriction to the relevant modes, to the relevant excitations and to the relevant nodes thus makes it possible to greatly limit the calculation time and the memory load associated with the determination of the noise, without impacting the accuracy of the results.

This first set of steps thus makes it possible to characterize the structure of the electric machine and its vibratory behavior.

Secondly, or for example in parallel with the first set of steps, a second set of steps makes it possible to characterize the levels of operational forces of the machine, that is to say the complex amplitude (norm and phase) of each case of magnetic loading applied to the machine along its operating points.

It is thus understood that the set of operating points, that is to say a combination of torque and speed of the electric motor, corresponds to a variety of speeds according to which the machine is capable of operating. The set of magnetic states thus corresponds to the flux generated and/or to the forces in the machine when the latter operates in accordance with a given operating point.

Each magnetic state comprises, for example, a magnetic force torsor per stator tooth, comprising a radial force, a circumferential force and a moment. Thus, the set of magnetic states makes it possible to determine a set of operational levels and to evaluate the intensity, for example in N, of a given load according to an operating point.

In other words, the set of magnetic states corresponds to a set of excitation forces respectively associated with the operating points.

The set of operational loadings can thus be determined as a function of the set of magnetic states, for example by integrating the Maxwell tensor on a dental pitch from the distribution of the magnetic flux in the middle of the air gap Another more precise way of calculating the operational loading is to apply the method of virtual works based on the distribution of the magnetic field on the magnetic mesh, then to integrate the torsor of the forces per tooth. Independently of the method for calculating the selected magnetic force torsor, a Fourier series decomposition of the torsors is performed with a view to determining, for each loading case (for example: radial force of wavenumber r=0 applied to the stator) and each operating point, an amplitude in N and a phase in radians. Thus, the determination of the information representative of the noise and vibration level of electromagnetic origin corresponds to a mapping of the frequency response functions, that is to say vibrations generated by unit loadings, with the operational loadings, that is to say the intensity of the loadings during the operation of the machine.

The information representative of the noise and vibration level of electromagnetic origin therefore comprises a noise and vibration level as a function of the operating points, that is to say combinations of torque and speed, making it possible to identify the noise-generating operating points. It is therefore possible, on the basis of this information, to adapt the control of the electric machine so as to avoid the greatest vibrations, and to minimize the noise and the risks of failure.

The Applicant thus submits that, thanks to the present invention, the determination of the noise and vibration level of magnetic origin of an electric machine is simplified with reduced calculation times, by performing calculations only on a reduced number of nodes, of eigenmodes and of loading case, making it possible to effectively integrate the electromagnetic vibratory analysis in a process of designing electric machines.

In an advantageous embodiment of the invention, the method further comprises a display, via a human-machine interface, of information belonging to a set of information comprising:
the information representative of the noise and vibration level;
information representative of the subset of loading cases and significant eigenmodes; and
information representative of the set of frequency response functions.

It will be understood here that the display of the representative information corresponds to a rendering, preferably a visual or graphic rendering, of the noise and vibration level determined during the method or else other relevant elements able to assist the design process of the electric machine. Of course, such a display depends on the representative information determined, in particular its level of detail The method according to the invention makes it possible, for example, to estimate, in particular with respect to the variant embodiments described below, an overall level of noise or vibrations generated by the machine, in a global manner or according to determined points or surfaces, or else a specific level of noise or vibration resulting from a mode and/or a case of loading considered, according to the operational levels determined during the execution of the method. According to another variant, the method according to the invention makes it possible to estimate a coefficient representative of a correspondence between the loading cases and the eigenmodes of the subset of loading cases and of eigenmodes, for example via a projection as described below. The display then corresponds, for example, to the display of a set of projections between the loading cases and the eigenmodes, from which the subset of loading cases and eigenmodes is determined. It is further understood that the method can be configured for displaying a variety of quantities or functions determined during the execution of the method, in particular the frequency response functions associated with a plurality of loading cases.

In a particular embodiment, the method further comprises receiving information representative of a set of magnetic loadings associated with the machine, and wherein the obtaining of first data corresponds to a determination of the set of loading cases associated with the machine from the set of magnetic loadings.

It is understood here that the method determines the set of loading cases by following the principle of a decomposition on a mathematical basis, applied to the set of magnetic loadings. The decomposition corresponds for example to a Fourier series decomposition or to any other mathematical base known to those skilled in the art.

The set of magnetic loadings is for example defined by a set of analytical equations on the structure of the forces, characterizing the frequency and the wavenumber of the rotor and stator loadings depending on the type of electric machine and its fault state.

According to another example, the information representative of the set of magnetic loadings comprises:
information representative of a number of stator slots of the machine;
information representative of a number of pairs of poles of the machine; and
information representative of a number of phases of the machine.

It will be understood that such information corresponds to discrete design parameters of the electric machine, from which the analytical equations of the spectral support of the loadings can be established.

According to an alternative variant, the obtaining of the first data item corresponds to a direct reception of the set of loading cases, for example determined analytically outside the execution of the method.

In an additional embodiment, the method further comprises receiving information representative of the mechanical structure, and wherein the obtaining of the second data corresponds to a determination of the set of eigenmodes from the structure.

The person skilled in the art understands here that the determination of all of the eigenmodes from the structure is performed for example analytically by modeling the stator by an equivalent cylinder or, more precisely, using a beam model, in which the teeth and the yoke of the stator are modeled as beam elements. The information representative of the structure of the machine corresponds, for example, to a model of the machine or to a set of parameters representative of the machine allowing it to be modeled.

According to other variant embodiments, the set of eigenmodes is received by the method and determined outside of its execution by methods known to those skilled in the art.

The set of eigenmodes is in this case for example determined by a calculation by mechanical finite elements, that is to say via a resolution of a problem of eigenvalues from matrices of stiffness and mass of the machine, or else measured via an experimental modal analysis.

In an additional embodiment, the method comprises the following steps:
determining a set of projections between the loading cases and the eigenmodes, each projection of the set of projections being associated with a loading case and an eigenmode; and
comparing each projection of the set of projections with a threshold value, the subset of loading cases and of significant eigenmodes being determined as a function of a result of the comparison.

In other words, each significant combination of a loading case and an eigenmode is identified when the projection of the loading case with the eigenmode exceeds a threshold value. The loading cases and the eigenmodes are for example represented in the form of representative vectors, each projection corresponding to a scalar product between the two vectors.

It is therefore understood here that a projection exceeding the threshold value corresponds to a combination of a loading case and a specific mode the shapes of which are similar, that is to say to an excitation entering into spatial resonance with a determined structure mode.

The comparison of each projection of the set of projections with a threshold value makes it possible, for example, to form a subset of significant projections, and by extension a subset of cases of loading and of significant eigenmodes.

According to yet another variant, the calculation of the set of projections makes it possible to identify, for each force, for example each loading case having a wavenumber of r=0, the mode the shape of which is closest to this force, that is to say the mode for which the projection with the case of loading is the highest.

In yet another embodiment, the method further comprises determining a set of resonance speeds from the subset of loading cases and significant eigenmodes, each resonance speed being associated with an eigenmode of the subset, and wherein the first set of operating points is associated with the set of resonance speeds.

It is understood here that the determination of the subset of cases of loading and of significant eigenmodes makes it possible to determine one or more speeds for which the combination of the case of loading and of the eigenmode enter into resonance. Each eigenmode is for example associated with a specific frequency or pulsation, from which a resonance speed can be determined, for example via the analytical equations described above.

The association of the first set of operating points with the resonant speeds, that is to say by including operating points whose speed corresponds to the resonance speeds, thus makes it possible to ensure that the calculations are carried out with respect to the speeds which are the most generating noise and vibrations, and therefore makes it possible to ensure a precise calculation. The first set of operating points is for example widened so as to include each identified resonance speed, so as to increase the accuracy of the calculation and/or restricted solely to the operating points associated with the resonance speeds identified to minimize as much as possible the calculation time.

In another embodiment that can be combined with the preceding modes, the method further comprises determining a set of cross-projection coefficient between the loading cases, each cross-projection coefficient being associated with a combination of two loading cases of the set of the loading cases, the information representative of the noise and vibrations level of electromagnetic origin being determined further as a function of the set of cross-projection coefficients.

The Applicant submits that the use of cross-projection coefficients makes it possible to obtain a plurality of independent coefficients of the operational loadings, involved in the expression of the mean square vibration speed of the envelope, representative of the overall noise level, and therefore to limit the calculations at the level of the determination of the information representative of the noise and vibration level of electromagnetic origin, that is to say to simplify the matching of the response functions and of the operational loadings. The determination of the set of cross-projection coefficients thus makes it possible to reduce the total number of calculations at variable speed and to facilitate the processing of a large number of operating points. The cross projection coefficients correspond for example, like the set of projections described above, to scalar products between the vectors representative of the loading cases. The cross-projection coefficients are for example advantageously determined only for the cases of loading of the subset of loading cases and of eigenmodes described above, or more generally only for the loading cases taken into account in the determination of the noise and vibration level of electromagnetic origin.

In yet another embodiment, the method further comprises obtaining sixth data representative of a set of radiation factors, each radiation factor being associated with an eigenmode of the set of eigenmodes, the information representative of the noise and vibration level of electromagnetic origin being determined further as a function of the sixth data.

The Applicant submits that the use of radiation factors, associated with each eigenmode, makes it possible to refine the calculations, in particular power and acoustic pressure calculations, that is to say information representative of the noise and vibration level. The accuracy of the results obtained is therefore improved, in particular in the context of low frequencies. According to yet another example, the radiation factors are used only in the context of excitation frequencies below a given threshold.

As stated above, the set of radiation factors is for example obtained only for the eigenmodes belonging to the subset of cases of loading and of significant eigenmodes.

Preferably, the method further comprises receiving information representative of the mechanical structure, and wherein obtaining the sixth data item corresponds to a determination of the set of radiation factors from the structure.

The Applicant submits that the set of radiation factors can be determined analytically in the execution of the method, for example by modeling the stator as an equivalent cylinder.

Those skilled in the art also understand that the set of radiation factors can be calculated by acoustic finite elements, from the modal deformation of each eigenmode.

The set of radiation factors is for example received directly, in parallel with the set of eigenmodes, or determined on the basis of the same piece of information representative of structure as the eigenmodes, for example in parallel with the determination of the eigenmodes, or else in a subsequent time, once the eigenmodes reduced to the subset.

In one embodiment, the set of relevant nodes comprises a first subset of nodes to which the magnetic forces are applied on the rotor and to the stator, a second subset of nodes generating acoustic noise radiation, and a third subset of isolated interface nodes.

The Applicant submits that these three subsets correspond to important nodes for the calculations, the set of relevant nodes being for example determined by identifying and grouping these three subsets. It is further understood that the set of relevant nodes can be determined in other ways according to the requirements and the knowledge of a person skilled in the art, so as to take into account the nodes whose behavior is important for the calculation of the vibrations.

In one particular embodiment, all of the frequency response functions comprise a set of response functions per loading case and optionally per eigenmode of the subset of loading cases and of significant eigenmodes, the information representative of the noise and vibration level of electromagnetic origin of the machine being determined separately for each loading case and optionally for each eigenmode.

The Applicant submits here that the set of frequency response functions corresponds, in the modal expansion carried out by the method, to a linear combination, for example a finite sum of responses per loading case and per eigenmode. This design thus makes it possible to separately calculate the responses per loading case or else the responses per loading case and by eigenmode, so as to determine and identify the noise and vibration level generated specifically by each loading case and optionally by each eigenmode, then the total noise level generated by their combination.

This combination provides in particular a finer analysis of the origin of the noise. A user is then able to identify, for each operating point, the loading cases and/or the eigenmodes of vibration generators, and consequently to adapt the design of the electric machine so as to attenuate them specifically. The user therefore understands what type of force excites what type of mode and can act both on the excitation, for example by adapting the design of the magnetic circuit of the machine, and on the structure, for example by moving a particular natural frequency, so as to reduce the noise and the vibrations.

In an additional embodiment, the set of frequency response functions comprises a set of acoustic frequency response functions.

In other words, the frequency response functions correspond to a response in acoustic pressure under the effect of a given loading, for example unitary. The frequency response functions are then calculated in the acoustic domain.

In another embodiment, the set of frequency response functions comprises a set of vibratory frequency response functions.

In other words, the frequency response functions correspond to a vibratory response under the effect of a given load.

Of course, it is further understood that the determination of the information representative of the noise and vibration level of electromagnetic origin of the machine is carried out as a function of the determined frequency response functions. In the context of acoustic frequency response functions, the information representative of the noise and vibration level corresponds for example to an acoustic pressure field under the effect of an operational excitation. The acoustic frequency response functions are for example determined on an acoustic mesh, once again restricted to the set of nodes relevant to a person skilled in the art (for example: points surrounding the machine for calculating the acoustic power according to the current standard). On the contrary, in the context of vibratory frequency response functions, the information representative of the noise and vibration level corresponds for example to a mean square vibration associated with at least one part of the machine.

It is also possible to determine a set of frequency response functions comprising both a set of acoustic frequency response functions and a set of vibrational frequency response functions. This design corresponds for example to a combined mechanical-acoustic calculation, or else, by combination with the variants described above, to an acoustic calculation separated from a radiation calculation, the radiation being combined with the vibratory frequency response functions to obtain the set of acoustic frequency response functions.

In an additional embodiment, the method further comprises receiving information representative of a second set of operating points of the machine, and wherein obtaining the first set of operating points comprises processing the second set of operating points.

It is understood here that the second set of operating points corresponds to a set of points provided for the execution of the method, the generation of the first set of operating points making it possible to complete and/or reduce the number and the nature of the operating points, for example so as to place the operating points in correspondence with the resonance speeds determined above or to reduce the operating points and the associated calculations. The determination of additional operating points is performed for example by interpolation or extrapolation from the second set of operating points.

In one embodiment that can be combined with the previous embodiment, the set of magnetic states is obtained from the first set of operating points.

It is understood here that the magnetic states correspond to the magnetic field in the machine, associated with the operating points. The magnetic state of the machine can be calculated in a plurality of ways, for example by magnetic finite elements, by the method of permeance or magnetomotive force, by networks of reluctances, or else by equivalent electrical circuits. The magnetic states then make it possible to determine the operational loadings associated with the operating points, for example according to the methods described above of the Maxwell tensor or virtual works.

In a particular embodiment, the method comprises receiving information representative of the magnetic states, for example direct reception of the fifth data, or else receiving a distribution of the magnetic flux in the air gap, from which the method determines the magnetic force torsors on the stator teeth, for example by the Maxwell tensor method.

Over certain operating ranges, the amplitude of the magnetic loadings can be known as constant or variable Thus, the determination of the set of magnetic states, as well as operating points, may comprise an extrapolation, the method determining the magnetic state of the machine on a single operating point of the range and extrapolating the amplitude and frequencies of the excitation harmonics over the operating range, or else an interpolation between two known operating points Of course, the operating points used for the interpolation are chosen so as to minimize the error committed, that is to say the inaccuracy, during interpolation. It is further understood that the use of interpolation and/or extrapolations over determined ranges also makes it possible to minimize the calculation load, the identification of such ranges ensuring that the accuracy of the results is not affected. By way of example, it is known that the amplitude of the magnetic loadings can be constant over operating ranges of asynchronous machines with a constant flux, an open-circuit magnet machine or a constant current angle.

According to another variant embodiment, the first set of operating points and the set of magnetic states associated with the operating points are both imported directly, the magnetic states being for example determined outside the execution of the method by magnetic finite elements.

In yet another embodiment, the method further comprises receiving information representative of a selection of a target belonging to a set of targets comprising:
a root mean square vibration of a surface of the machine;
a root mean-square vibration of at least one node of the machine; and
an acoustic power radiated by a part or all of the machine, the information representative of the noise and vibration level of electromagnetic origin of the machine being further determined as a function of the selection.

It is understood here that it is possible, via the execution of the method according to the invention, to obtain a plurality of pieces of information each being representative of the level of noise and vibrations of electromagnetic origin, the use and usefulness of which can vary depending on the cases of application. In particular, a user may seek to obtain a result on a restricted portion of the machine, resulting from the vibratory behavior of the whole machine, for example a given surface or point. This design thus makes it possible to determine precisely which level of noise and vibrations to determine during the course of the execution of the method, in particular for a display of this information in accordance with the variant described above.

According to a second aspect, the present invention relates to a device for determining a noise and vibration level of electromagnetic origin of an electric motor machine, the device comprising a memory associated with a processor configured to implement the steps of the method according to the first aspect of the present invention.

According to a third aspect, the present invention relates to a computer program which comprises instructions for carrying out the method according to the first aspect of the present invention, in particular when these instructions are executed by at least one processor.

According to a fourth aspect, the present invention relates to a computer-readable storage medium on which is recorded a computer program comprising instructions for implementing the steps of the method according to the first aspect of the invention. On the one hand, the recording medium can be any entity or device capable of storing the program. For example, the medium may comprise a storage means, such as a ROM memory, a CD-ROM or a ROM memory of the microelectronic circuit type, or else a magnetic recording means or a hard disk.

Furthermore, this recording medium can also be a transmissible medium such as an electrical or optical signal, such a signal being able to be conveyed via an electrical or optical cable, by conventional radio or over-the-air or by self-directed laser beam or by other means. The computer program according to the present invention may in particular be downloaded from an Internet type network.

Alternatively, the recording medium may be an integrated circuit in which the computer program is incorporated, the integrated circuit being adapted to execute or to be used in the execution of the method in question.

According to a fifth aspect, the present invention relates to a use of the method according to the first aspect of the present invention for designing an electric motor machine. It is understood here that the design of an electric motor machine comprises the production of a plurality of prototypes or models of machines, for which it is advantageous to determine at the earliest the magnetic behavior (for example: torque, losses) and vibro-acoustic behavior, in order to identify and correct any defect, in particular by adapting the magnetic excitation and/or the physical structure, by minimizing investments and manufacturing costs.

The method according to the present invention thus allows rapidity of execution which makes it possible to launch sensitivity and optimization studies, that is to say the integration of the method in a design phase, on an industrial scale, of electric motor machines.

Thus, by the different functional and structural technical features above, the applicant proposes a method and a device for determining a noise and vibration level of electromagnetic origin of an electric motor machine allowing a large reduction in the calculation time and an integration in an industrial method for designing and/or prototyping an electric motor machine.

### BRIEF DESCRIPTION OF THE DRAWINGS

Other characteristics and advantages of the present invention will emerge from the description of the particular and non-limiting exemplary embodiments of the present invention below, with reference to the appended FIGS. 1 to 6, and in which:

FIG. 1 illustrates the structure and the mechanical mesh of an electric motor machine, according to a particular and non-limiting exemplary embodiment of the present invention;

FIG. 2 schematically illustrates a device configured to determine a noise and vibration level of electromagnetic origin of the machine of FIG. 1, according to a particular and non-limiting exemplary embodiment of the present invention;

FIG. 3 illustrates a flowchart of the various steps of a method for determining a noise and vibration level of electromagnetic origin of the machine of FIG. 1, according to a particular and non-limiting exemplary embodiment of the present invention;

FIG. 4 illustrates a first graph representative of a noise and vibration level of electromagnetic origin of the machine of FIG. 1, determined by a method according to FIG. 3;

FIG. 5 illustrates a second graph representative of a noise and vibration level of electromagnetic origin of the machine of FIG. 1, determined by a method according to FIG. 3;

FIG. 6 illustrates a third graph representative of a noise and vibration level of electromagnetic origin of the machine of FIG. 1, determined by a method according to FIG. 3.

### DETAILED DESCRIPTION

A method and a device for determining a noise and vibration level of electromagnetic origin of an electric motor machine will now be described with reference to FIGS. 1 to 6. The same elements are identified with the same reference signs throughout the following description.

As indicated in the preamble of the description, the current solutions for determining the noise and vibration level of electromagnetic origin correspond to generic software, not adapted to this particular task, the calculation times of which are considerable and unsuitable for industrial needs.

One of the objectives of the present invention is to propose a determination of the noise and vibration level of electromagnetic origin, the operation of which is adapted to its integration in the design of an electric machine, in particular in sensitivity and optimization studies.

This is made possible in the example described below, in which the method according to the invention is used in a design phase of an electric machine.

It will be understood here that this example is not limiting and that the method according to the invention can be integrated into a variety of different phases involving the vibratory analysis of an electric motor machine.

According to the example of FIG. 1, a machine 1 includes an electric motor, comprising a rotor 11 and a stator 12 separated by an air gap 13. The machine 1 corresponds, for example, to a model of an electric machine in the design phase, or to a physical prototype whose vibratory behavior is to be studied in detail, for example in order to identify more precisely the sources of its vibrations. The machine 1 corresponds, for example, to a synchronous machine, to an asynchronous machine, or to a variable reluctance machine. Of course, according to other examples, the machine 1 may comprise several rotors 11 and/or several stators 12.

A rotating electrical machine generally consists of two main parts: the rotor 11 and the stator 12, the connection of which is provided by a bearing. The air gap 13 designates the space situated between the rotor 11 and the stator 12, the electromechanical conversion taking place in the air gap. The electric machine may contain several rotors and several stators, which does not affect the described method if it is only the number of cases of magnetic loading. The stator 12 is a fixed part which is made of ferromagnetic material and which comprises called stator slots 12a, 12b, 12c filled with a winding; this winding is connected to a source capable of electrically powering the winding of the stator 12 with so-called stator currents. These stator currents create a magnetic field rotating in the air gap 13 of the machine 1.

The rotor 11 is for its part an elongate part which is made of ferromagnetic material and which is able to rotate about its own longitudinal axis, for example around a shaft 15.

According to the example of FIG. 1, the machine 1 corresponds to a synchronous machine with magnets 14, the stator slots 12a, 12b, 12c comprising a first set of notches 12a associated with a first phase, a second set of notches 12b associated with a second phase and a third set of notches 12c associated with a third phase.

In another example, the machine 1 corresponds to an asynchronous machine. In such an example, the rotor 11 comprises so-called rotor slots filled with a coil traversed by currents, called rotor currents, which are induced by the fluctuations of the magnetic field generated by the stator 12.

During the operation of the machine 1, that is, the operation of the electric motor, the rotor 11 starts to turn in an attempt to follow the magnetic field generated by the stator 12 according to the Lenz-Faraday law. In an asynchronous machine, the speed of mechanical rotation of the rotor 11 differs slightly from the speed of rotation of the stator field, whereas in a synchronous machine, the rotor 11 rotates synchronously with the magnetic field of the stator 12.

The electromagnetic forces at the origin of the torque in the air gap 13 are also the cause of vibrations and acoustic noise: the forces generated deform the structures of the rotor 11 and of the stator 12 and propagate more generally to the whole of the physical structure of the machine 1. The vibrations generated can, on the one hand, propagate to the ambient air and radiate in the audible frequencies, representing a source of discomfort, on the other hand to cause mechanical fatigue which can be damaging for applications where the operation of the machines must be guaranteed over long periods, for example for hydroelectric or wind turbine generators.

These electromagnetic forces mainly originate from the interaction between the different harmonic groups of magnetic flux (Maxwell forces); the harmonics of magnetic flux are themselves derived from the interaction between different so-called magnetic permeance and magnetomotive force harmonics.

It therefore appears that resolving and identifying the sources of vibrations of electromagnetic origin, or more simply determining whether a given machine is likely to generate vibrations, represents a complex problem, in particular during preliminary design phases. If there are at present combinations of software solutions making it possible to estimate the noise of electromagnetic origin of a given machine, these are complex and particularly time-consuming.

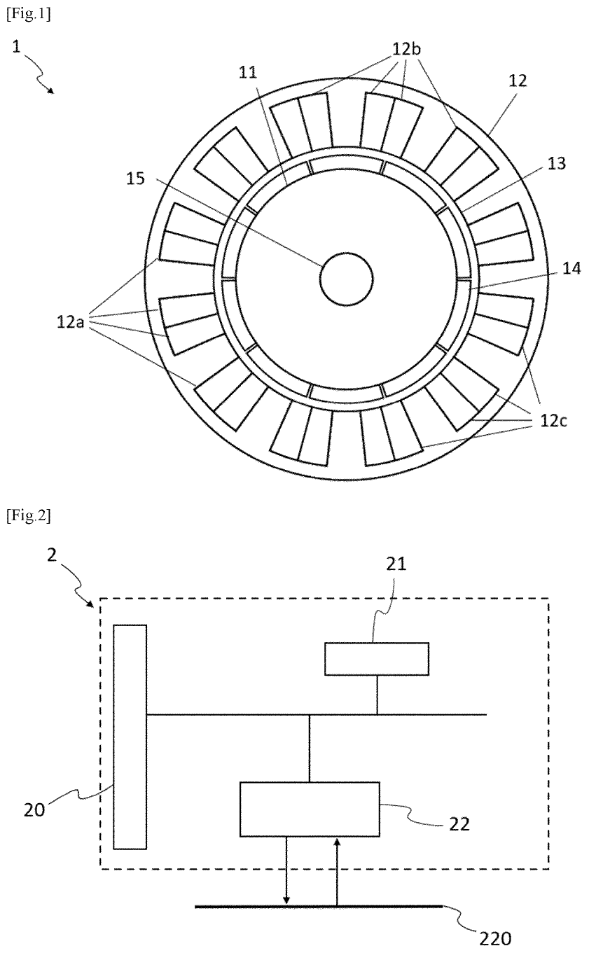

In order to propose a solution to this problem, the machine 1 is associated with computer means configured to implement a method for determining its noise and vibration level of electromagnetic origin, for example the method of FIG. 3. As illustrated in FIG. 2, such computer means are for example advantageously grouped together in an electronic device 2, for example a computer (hereinafter referred to as a “calculator”). The computer 2 is for example configured to transmit and receive data inside a communication network. The elements of the computer 2, individually or in combination, can be integrated into a single integrated circuit, in several integrated circuits, and/or in discrete components. The computer 2 can be produced in the form of electronic circuits or software (or computer) modules or even a combination of electronic circuits and software modules.

The computer 2 comprises one (or more) processors configured to execute instructions for carrying out the steps of the method and/or for the execution of the instructions of the embedded software(s) in the computer 2. The processor may include an integrated memory, an input/output interface, and various circuits known to those skilled in the art. The computer 2 further comprises at least one memory corresponding for example to a volatile and/or non-volatile memory and/or comprises a memory storage device which may comprise volatile and/or non-volatile memory, such as EEPROM, ROM, PROM, RAM, DRAM, SRAM, flash, magnetic or optical disk.

The computer code of the embedded software(s) comprising the instructions to be loaded and executed by the processor is for example stored on the memory of the computer 2.

According to a variant embodiment, the computer 2 is configured to implement a method for determining a noise and vibration level of electromagnetic origin as a part of a broader method, for example a method for designing an electric motor machine, in which the quantities calculated during the method according to the invention, for example the acoustic power or the noise and vibration level per loading case and optionally per eigenmode, are calculated, in this example, at each iteration of the design method. The method according to the invention may also, according to one example, be performed iteratively for a plurality of machines 1 corresponding to different designs, so as to provide a comparison between the different designs. The method for designing an electric motor machine comprises for example the creation of the model of the machine 1, the information associated with the model being recorded in a memory 20 of the computer 2.

In a first step 31 of the method for determining the noise and vibration level, the computer 2 obtains a first data representative of a set of loading cases associated with the machine 1. Each loading case here corresponds to a component of a magnetic loading according to a decomposition on a mathematical basis, for example in Fourier series. Preferably, each loading case corresponds to a unit loading and is characterized by a type of loading, an application direction, an application structure and a wave number r. By way of example, a case of magnetic loading corresponds to a radial force on the rotor of spatial frequency r=0.

The first data item is for example received by a beacon unit 22 of the computer 2, for example a beacon unit 22 in communication with a human-machine interface 220 of the computer 2. the computer 2 forms, for example, a communication network, for example a multiplexed communication network, in which data are transmitted via a wireless or wired link. The computer 2 therefore establishes a communication between the human-machine interface 220, serving as a data acquisition peripheral, and the beacon unit 22 so as to allow the exchange of data.

According to another example in accordance with the variant described above, the first data is obtained from the memory 20 of the computer 2. The first data corresponds in these two cases to an input data, the set of loading cases having been determined outside the execution of the process, for example analytically.

According to a variant embodiment, the computer 2 receives, for example via the beacon unit 22 or the memory 20, information representative of a set of magnetic loadings associated with the machine 1. a processor 21 of the computer then determines the set of loading cases associated with the machine 1 from the set of magnetic loadings.

The information representative of the set of magnetic loadings corresponds for example to a set of analytical equations, making it possible to characterize the frequency and the wavenumber of the effective loadings, for example as a function of the type of machine 1, and/or to parameters of these analytical equations. Such analytical equations are also established on the basis of discrete design parameters of the machine 1.

According to an exemplary embodiment, an open-circuit permanent magnet machine is associated with the following analytical equations:

$$r = {k}_{s} {Z}_{s} + {h}_{r} 2 p [ \frac{{Z}_{s}}{2} ] \qquad [ Math 1 ]$$

$$f = {h}_{r} 2 {f}_{e} \qquad [ Math 2 ]$$

With r is the number of waves of the load, f is the frequency of the load, kₛ and hᵣ are two relative integers from the Fourier series decomposition of the magnetic flux, fₑ is the electrical frequency proportional to the operating speed, Zₛ is the number of slots of the stator 12 and p is the number of pairs of poles of the machine. The term modulo [Zₛ/2] relates to the wave numbers of the forces seen by the stator toothing due to the spatial sampling phenomenon.

By way of example, in the context of a machine 1 for which:

$$p = 4 \qquad [ Math 3 ]$$

$$and$$

$${Z}_{s} = 48 \qquad [ Math 4 ]$$

The machine 1 contains a wavenumber excitation:

$$r = 0 = 48 - 6 * 8 \qquad [ Math 5 ]$$

And an associated frequency:

$$f = - 12 {f}_{e} \qquad [ Math 6 ]$$

Also with

$${h}_{r} = - 6 \qquad [ Math 7 ]$$

Such an excitation occurs both in the radial and circumferential directions, on the stator 12 and on the rotor 11.

Distinct analytical formulae are used for other types of machines 1, in particular synchronous machines, asynchronous machines and variable reluctance machines. Such analytical formulae can also be established in charge from the number of phases qₛ of the machine 1. The analytical formulae can also be modified to take into account the cases of defects, for example an eccentricity adding new cases of loading.

The higher the wave number of the excitations, the less the vibrations are. These analytical formulae therefore also make it possible to restrict the field of study both in terms of wave numbers and maximum frequency, which reduces the calculation time. A priori knowledge of the frequencies also makes it possible to optimize the temporal sampling of the electromagnetic simulation.

Thus, according to one example, the information representative of the set of magnetic loadings comprises information representative of a type of machine as well as a plurality of information representative of design parameters of the machine 1, in particular the parameters Zₛ, p and qₛ.

In a second step 32, the computer 2 obtains a second data representative of a set of eigenmodes of a mechanical structure of the machine 1.

Like the alternative embodiments described above, the second data is, according to an example, directly received from the beacon unit 22 or the memory 20 of the computer 2. The second data is in this case for example determined by mechanical finite elements or measured by experimental modal analysis, by the use of an excitation hammer on a physical machine 1.

According to another example, the computer 2 receives information representative of the mechanical structure, for example the model of the machine 1 or parameters representative of its structure, for example the rotor 11 and/or the stator 12, from which the processor 21 determines the set of eigenmodes. The processor 21 determines, for example, the eigenmodes on the basis of parameters representative of the stator 12, by modeling it by an equivalent cylinder or more precisely by modeling the teeth and the yoke of the stator 12 in beam elements.

In each of these exemplary embodiments, the set of eigenmodes of the mechanical structure corresponds to a series of modes characterized respectively by a modal deformation, a natural frequency and a modal damping.

In a third step 33, the computer 2, for example the processor 21, determines a subset of cases of loading and of significant eigenmodes. In other words, the processor 21 determines which loading cases and which eigenmodes are the most likely to contribute to the vibrations. The vibrations resulting from a resonance between a loading case and an eigenmode, it is understood here that the subset of cases of loading and of eigenmodes corresponds to the combinations, two by two, of case of loading the shape of which is close to an eigenmode, or vice-versa.

According to a variant, the processor 21 determines a set of projections between the loading cases and the eigenmodes. Each case of loading and each eigenmode is for example represented in the form of a vector, the processor 21 calculating, for each combination of loading cases and eigenmode, a scalar product between the two vectors corresponding to a projection.

The determination of the subset of cases of loading and of significant eigenmodes results, for example, from a comparison, for each combination, of the associated projection with a threshold value, for example a threshold value recorded in the memory 20 of the computer 2 or else a threshold value corresponding to an input data received by the beacon unit 22. The threshold value is for example determined so as to establish a level of precision of the calculations, a higher threshold value making it possible to limit the number of cases of loading and of significant eigenmodes, and therefore to limit the calculations performed.

Optionally, the computer 2 also determines, from the subset of cases of loading and of significant eigenmodes, a resonance speed. The resonance speed corresponds for example to the electrical frequency fₑ described above. Each eigenmode being characterized by a natural frequency f₀ and the machine 1 being advantageously characterized by analytical equations characterizing its frequency f as a function of the electrical frequency fₑ, it becomes possible to determine a resonance speed, that is to say an electrical frequency fₑ associated with the resonance of an eigenmode with a loading case.

In accordance with the example described above, the processor 21 calculates, for example, a projection of the excitations whose wavenumber r=0, corresponding to the most important excitations, in order to identify the mode whose shape is closest to this force. For example, the projection between the modes and a unit force r=0 in the radial direction makes it possible to identify a particular eigenmode, referred to as the stator breathing mode. In accordance with the analytical equations given above, one then obtains:

$${f}_{0} = 12 {f}_{e} \qquad [ Math 8 ]$$

And the resonance speed, corresponding to the electrical frequency fₑ associated with the combination between the loading case and the eigenmode, is then determined from the natural frequency f₀ of the breathing mode.

In a fourth step 34, the computer 2 obtains a third data representative of a set of relevant nodes associated with the mechanical structure. From this set of relevant nodes, the computer 2 calculates, in a fifth step 35, a set of frequency response functions by using modal expansion. Modal expansion, known to those skilled in the art, is in particular restricted to the relevant nodes and to the subset of cases of loading and of significant eigenmodes, so as to reduce the main source of computation time and bulk in memory.

By way of example, the generic modal expansion formula is given by:

$$x {\vert}_{I} ( ω ) = {\sum }_{m ∈ j} \frac{[ {Φ}_{m}^{T} F ( ω ) ] {Φ}_{m} {\vert}_{I}}{{ω}_{m} + 2 j ω {ξ}_{m} {ω}_{m} - {ω}^{2}} \qquad [ Math 9 ]$$

With x the complex harmonic displacement restricted to the set of nodes of interest I, ωₘ the natural frequency of the eigenmode m in rad/s, the modal damping of mode m, ξₘ the modal shape of mode m among the subset of modes J, F the magnetic excitation force in N, and co the frequency of the excitation in rad/s.

In other words, the computer determines a set of nodes of the machine 1 to which the modal expansion calculations will be restricted. Modal expansion is also restricted to the subset determined above, so as to specifically study the responses capable of generating resonances.

According to an advantageous variant, the set of relevant nodes comprises a first subset of nodes for which the magnetic forces are applied to the rotor 11 and to the stator 12, a second subset of nodes generating acoustic noise radiation and a third subset of isolated interface nodes. In other words, the subsets correspond to different criteria making it possible to identify the relevant nodes, in order to ensure correct calculations while restricting the total number of nodes. According to another example, the relevant nodes correspond to the nodes arranged, in the structure of the machine 1, at the level of the tooth heads and at the attachment points of the machine 1.

It is understood here that each frequency response function corresponds to the behavior of a node, as a function of the frequency of the electric motor, resulting from the interaction of the loading cases with the eigenmodes. The response may correspond to an acoustic pressure response, in the context of acoustic frequency response functions, or to a vibratory response, that is to say a deformation of a node, in the context of vibratory frequency response functions.

By way of example, in a finite element mechanical model, in which the outer surface envelope S of the machine 1 is discretized into a mesh of Nₑₗₑₘ elements of index e included in the interval [1, Nₑₗₑₘ], of elementary surface dSₑ, of normal vector ne and centered on the point Cₑ, the normal deformation Un of an element by modal expansion is given by the following formula:

$${U}_{n} ( {C}_{e} , f ) = {\sum }_{m = 1}^{Nmode} {Φ}_{m} ( {C}_{e} ) \cdot {n}_{e} {ψ}_{m} ( f ) {H}_{m} ( f ) \qquad [ Math 10 ]$$

In which N_{mode} is the total number of eigenmodes considered, and ψₘ(f) is the mode projection factor of the mode m defined such that:

$${ψ}_{m} ( f ) = {\sum }_{k = 1}^{Nnoeud} {Φ}_{m} ( {P}_{k} ) \cdot {F}_{k} ( f ) \qquad [ Math 10 ]$$

With Fₖ(f), the case of loading associated with the projection and Hm the amplification factor such that:

$${H}_{m} ( f ) = \frac{1}{4 {π}^{2}} \frac{1}{{f}_{m}^{2} - {f}^{2} + j 2 {ξ}_{m} {f}_{m} f} \qquad [ Math 11 ]$$

The Applicant submits in particular that the direct calculation of the frequency response functions by modal expansion, according to the generic formula of modal expansion given above, is advantageous for reducing the calculation time when the number of loadings to be processed is high.

According to a particular variant embodiment, the frequency response functions are determined separately for each loading case and/or for each eigenmode. The person skilled in the art understands here that the response of a node to a set of cases of loading and eigenmodes corresponds to a linear combination of individual responses to each pair of loading cases and of eigenmode. It is therefore possible to separately calculate the frequency response functions for each case of loading with respect to all the eigenmodes or else individually for each combination of loading cases and eigenmode. In particular, the frequency response functions can be determined solely with respect to the unique combinations of loading cases and eigenmodes of the subset determined above, their prior selection corresponding to the vibration-generating combinations.

Thus, by way of example, the deformation Un of a node can be calculated separately for each separate excitation, in particular using the following formula:

$${U}_{n} ( {C}_{e} , f ) = {\sum }_{i = 1}^{Nlc} {U}_{n , i} ( {C}_{e} , f ) = {\sum }_{i = 1}^{Nlc} {WFRF}_{i} ( {C}_{e} , f ) \cdot {F}_{i} ( f ) \qquad [ Math 12 ]$$

In which WFRFᵢ corresponds to the frequency response function associated with the case of loading i comprised in the interval [1, N_{lc}] with N_{lc} the number of cases of loading, and Fᵢ the complex amplitude of the case of loading i.

Similarly, each frequency response function can be separated according to the eigenmodes from the following formula:

$${WFRF}_{i} ( {C}_{e} , f ) = {\sum }_{m = 1}^{Nmode} {Φ}_{m} ( {C}_{e} ) \cdot {n}_{e} {ψ}_{m} ( f ) {H}_{m} ( f ) \qquad [ Math 13 ]$$

With ψ_{i,m} the projection of the loading case i with mode m.

In particular, the Frequency Response Functions, also called FRF, make it possible to determine a response proportional to a given amplitude load, for example a unit load.

In a sixth step 36, the computer 2 obtains a fourth data item representative of a first set of operating points of the machine 1. each operating point corresponds to a torque and to a speed of the machine 1, that is to say to a speed under which the engine is likely to operate.

Like the variants described above, the fourth data is for example directly received from the beacon unit 22 or from the memory 20, or else determined by the processor 21. The computer 2 receives for example a second set of operating points, from which the processor 21 determines the first set of operating points.

It will be understood here that the determination of the first set of operating points corresponds to the establishment of a given number of operating points, sufficient to establish the behavior of the machine 1. the number and the nature of the operating points naturally depend on the operating criteria known to those skilled in the art. By way of example, it is possible to construct a first set comprising 200 operating points.

According to an advantageous variant, the first set of operating points is associated with the resonance speeds determined above, so as to ensure that the calculations are performed at the speeds for which the determination of the subset of loading cases and of significant eigenmodes indicates a resonance. It is understood here that, in this case, the obtaining of the fourth data is carried out following the determination of the subset of loading cases and of significant eigenmodes. In other cases, the obtaining of the fourth data item can be carried out in another time, for example in parallel or upstream of the operations described above.

In accordance with the example above, the first set of operating points comprises for example one or more points for which the speed corresponds to the electrical frequency fₑ resulting from the breathing mode of the stator 12, associated with one or more torque levels. In a seventh step 37, the computer 2 obtains a fifth data representative of a set of magnetic states of the machine 1. The computer obtains in particular the distribution and the amplitude of the magnetic forces in the machine 1.

Once more, the obtaining of the fifth data varies according to the design and the type of input data. According to several examples, the computer determines the electromagnetic state of the machine according to the magnetic finite element method, the magnetomotive permeance/force method, or the magnetic reluctance network method, which may or may not be coupled to an equivalent electrical circuit. It is understood here that one or the other of these methods can be selected by a person skilled in the art based on different criteria, in particular according to various compromise between calculation time and accuracy. According to yet another variant, the computer 2 directly receives the fifth data, in particular in parallel with the first set of operating points.

According to one example, each magnetic state comprises a magnetic force torsor per stator tooth, each torsor comprising a radial force, a circumferential force, and a moment.

Furthermore, each magnetic state of the set of magnetic states is associated with an operating point of the first set of operating points. Of course, the obtaining of the set of magnetic states also depends on the obtaining of the first set of operating points.

In particular, when the processor 21 determines a set of magnetic states associated with a large number of operating points, the calculations can be reduced by interpolation or extrapolation of the forces, that is to say along specific operating ranges, for example for a fixed torque or speed, or even for the same torque/speed ratio.

Depending on the operating range considered, the magnetic loadings may be of constant amplitude, in which case the processor 21 determines a magnetic state associated with an operating point and extrapolates it over the range. By way of example, such an extrapolation can be applied to an asynchronous machine with constant flux, a machine 1 with open-circuit magnets or with a constant current angle.

According to other operating ranges, the processor 21 can interpolate the forces between two operating points, by selecting the operating points so as to minimize the error made. By way of example, the variations of the current vector are limited between two successive operating points.

In an eighth step 38, the computer 2 then determines a set of operational loadings from the set of magnetic states.

In particular, like loading cases, the operational loadings correspond to a decomposition of the magnetic forces, so as to determine, for a given operating point, an amplitude, for example in N, of each loading case.

The computer 2 therefore deduces the set of operational loadings from the fifth data, for example by the Maxwell tensor method. According to another variant, the fifth data comprises a distribution of the magnetic field on a magnetic mesh of the machine 1 and the computer 2 applies the method of virtual works and integrates the torsor of the forces by teeth in order to deduce the set of operational loadings.

Thus, the operational loadings make it possible to determine the amplitude of the loading cases determined above, for example the complex amplitude Fi (f) stated above. Finally, in a ninth step 39, the computer determines information representative of a noise and vibration level of electromagnetic origin of the machine 1 from the set of operational loadings and from the set of frequency response functions.

It is understood here that this determination corresponds to a mapping of the frequency response functions, that is to say of the vibratory or pressure reaction in response to a given load, with the actual intensity of each load according to the operating point of the machine 1.

It is further understood that the information can be determined with more or less details according to the steps of the method. In particular, the information is for example determined separately for each loading case and/or for each eigenmode, the total noise level corresponding to a linear combination of the set of determined information.

By way of example, the information representative of the noise and vibration level of electromagnetic origin corresponds to a mean quadratic speed v²ᵣₘₛ determined via the so-called electromagnetic vibratory synthesis formula:

$${v}_{rms}^{2} ( f ) = {( j 2 π f )}^{2} {\sum }_{i = 1}^{Nlc} {\sum }_{j = 1}^{Nlc} {\sum }_{h = 1}^{Nslice} {\sum }_{v = 1}^{Nslice} {C}_{i , j} {F}_{i} ( f , h ) {f}_{j}^{*} ( f , v ) \qquad [ Math 14 ]$$

In which Cᵢⱼ corresponds to a cross-projection coefficient between the cases of loading of indices i and j, and is given by the formula:

$${C}_{i , j} ( f , h , v ) = {\sum }_{m = 1}^{Nmode} {\sum }_{l = 1}^{Nmode} {φ}_{m , l} {ψ}_{l , m} ( h ) {H}_{m} ( f ) {ψ}_{j , l}^{*} ( v ) {H}_{l}^{*} ( f ) \qquad [ Math 15 ]$$

In which φ_{m,l} corresponds to the projection of the modal shapes associated with modes m and l, such as:

$${φ}_{m , l} = \frac{1}{S} {\sum }_{e = 1}^{{N}_{elem}} {Φ}_{m} ( {C}_{e} ) \cdot {n}_{e} {Φ}_{l} ( {C}_{e} ) \cdot {n}_{e} {dS}_{e} \qquad [ Math 16 ]$$

In particular, it appears that the cross projection coefficients Cᵢⱼ, just like the projection of the modal shapes φ_{m,l} are independent of the operational loading. According to an advantageous variant embodiment, the computer 2 thus determines a set of cross-projection coefficients between the loading cases, and calculates the information representative of the noise and vibration level, for example the mean quadratic speed, as a function of this set of cross-projection coefficients. In other words, the set of cross-projection coefficients is recorded in a memory 20 of the computer, so as to simplify the calculations during the matching of the frequency response functions and of the operational level of each load.

Furthermore, according to the following identity:

$${C}_{i , j} = {C}_{j , i}^{+} \qquad [ Math 17 ]$$

It is also possible to determine only half of the cross projection coefficients. According to another example, the noise and vibration level of electromagnetic origin is determined in the acoustic domain, like the frequency response functions. The computer 2 carries out, for example, a mesh of the machine 1 according to the ISO3744 standard, the acoustic pressure p being given, for any point M of the ISO3744 mesh, by the formula:

$${\overline{p}}_{i} ( M , f ) = ( \frac{\overline{{WFRF}_{i}^{ap}} ( M , f ) {\overline{OLC}}_{i} ( f )}{\sqrt{2}} ) \qquad [ Math 18 ]$$

With WFRF^{ap}, the frequency response function in the acoustic domain and OLC the operational loading.

In the same example, the acoustic power W of the machine 1 is given by the formula:

$$\overline{W} ( f ) = {\sum }_{i = 0}^{Nlc - 1} {\overline{W}}_{i} ( f ) = {\sum }_{i = 0}^{Nlc - 1} [ {\sum }_{M}^{NISO 3744 - 1} abs [ {\overline{p}}_{i}^{2} ( M , f ) ] \frac{{W}_{0} \cdot {S}_{ISO 3744}}{{p}_{0}^{2} \cdot {N}_{ISO 3744}} \qquad [ Math 19 ]$$

With W₀ equal to 10⁻¹² W, P₀ equal to 20 μPa, S_{ISO3744} the total area of the mesh according to the standard ISO 3744 and N_{ISO3744} the total number of nodes according to standard ISO 3744.

It is further understood that the information representative of the level of noise and vibrations of sought electromagnetic origin and therefore the calculation methods used may vary as a function of the objective of a person skilled in the art. Thus, according to a particular variant embodiment, the computer 2 also receives information representative of the selection of a target belonging to a set of targets, for example from the beacon unit 22 in communication with the human-machine interface 220.

The set of targets comprises for example:
a root mean square vibration of a surface of the machine 1;
a root mean square vibration of at least one node of the machine 1; and
an acoustic power radiated by a part or the whole of the machine 1.

The information representative of the noise and vibration level of electromagnetic origin is then determined as a function of the selection made. Of course, it is understood that other elements may depend on this selection, for example the calculation of frequency response functions in the acoustic domain or in the vibratory domain.

According to yet another variant, the computer 2 obtains sixth data representative of a set of radiation factors, each radiation factor being associated with one eigenmode of the set of eigenmodes. The computer 2 receives for example directly the set of eigenmodes and the set of associated radiation factors, the radiation factors having been determined outside the execution of the method, for example by acoustic finite elements from the modal deformation of each mode. In another example, the set of radiation factors is determined, for example for each eigenmode of the subset of loading cases and of eigenmodes significant, on the basis of information representative of the mechanical structure of the machine 1. the radiation factors are then determined analytically, for example by modeling the stator 12 by an equivalent cylinder.

By way of example, the radiation factor cm of an eigenmode m of a cylinder finite length is given by the formula:

$${σ}_{m} ( f ) = {\int }_{- k}^{k} \frac{2 {kL}_{st}}{\begin{matrix}{π}^{2} {R}_{c} ( \sqrt{{{k}^{2} - {k}_{2}^{2} )}^{2}} \\ {\vert \frac{1}{2} ( {H}_{n - 1}^{( 2 )} ( {k}_{r} {R}_{c} ) - {H}_{n + 1}^{( 2 )} ( {k}_{r} {R}_{c} ) ) \vert}^{2}\end{matrix}} \cdot {[ \frac{m π / {L}_{st}}{{k}_{z} + m π / {L}_{st}} ]}^{2} \frac{{sin}^{2} [ {L}_{st} / 2 ( {k}_{z} - \frac{m π}{{L}_{st}}}{{L}_{st} / 2 ( {k}_{z} - m π / {L}_{st} )} \qquad [ Math 20 ]$$

where k is the wave number, R_{c} is the outer radius of the cylinder, Lₛₜ is the length of the cylinder, k_{z} is the longitudinal wave number and kᵣ is the radial wave number.

In this variant, the information representative of the noise and vibration level of electromagnetic origin is further determined as a function of the set of radiation factors associated with the eigenmodes. The Applicant submits that the use of radiation factors makes it possible in particular to ensure more accurate results in low-frequency calculations.

In the case where the radiation factors are imposed, the calculation formula of the vibrational frequency responses can be artificially altered as follows:

$${WFRF}_{i} ( {C}_{e} , f ) = {\sum }_{m = 1}^{Nmode} \sqrt{{σ}_{m} ( f )} {Φ}_{m} ( {C}_{e} ) \cdot {n}_{e} {ψ}_{i , m} {H}_{m} ( f ) \qquad [ Math 21 ]$$

In such a way that the vibration electromagnetic synthesis formula can be preserved, the acoustic power level then taking into account the effect of the modal radiation factors.

Thus, the ninth step 39 makes it possible to obtain a set of noise levels as a function of the operating points of the machine 1, allowing at least to identify the combinations of torque and noise generating speed.

Optionally, the computer 2 then proceeds to display the information representative of the noise and vibration level via a human-machine interface in communication with the computer 2. The computer 2 communicates for example with the human-machine interface 220 via the beacon unit 22 or another dedicated unit so as to allow the display of a graphical content representative of the determined noise and vibration level.

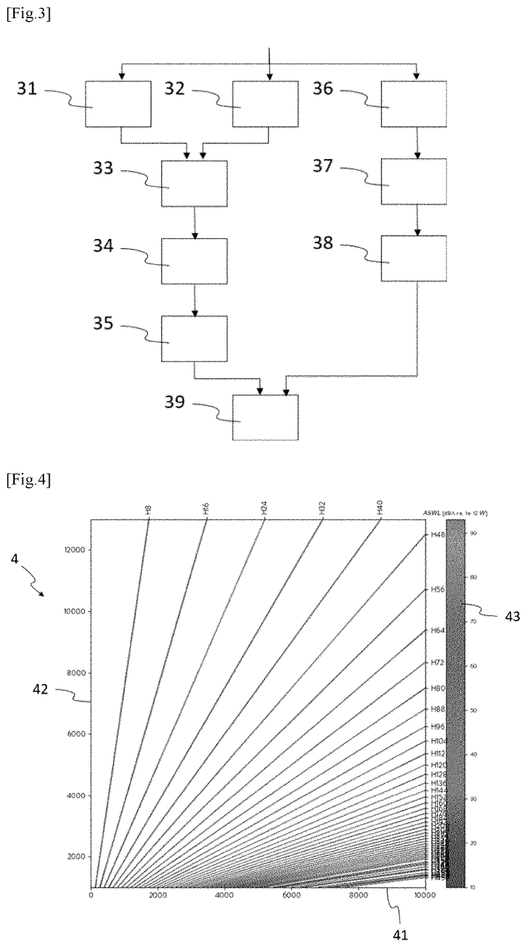

The graphical content corresponds for example to one or more of the graphs illustrated in FIGS. 4 to 6.

Thus, the first graph 4 of FIG. 4 corresponds to a spectrogram illustrating the evolution of the acoustic power 43, in dB, along curves defined by the frequency 41, in Hz, and the speed of rotation 42, in revolutions per minute, of the machine 1. It then becomes possible to deduce the most noisy excitations, for example the excitations H24 and H48, corresponding to a ratio between the frequency 41 and the speed of rotation 42.

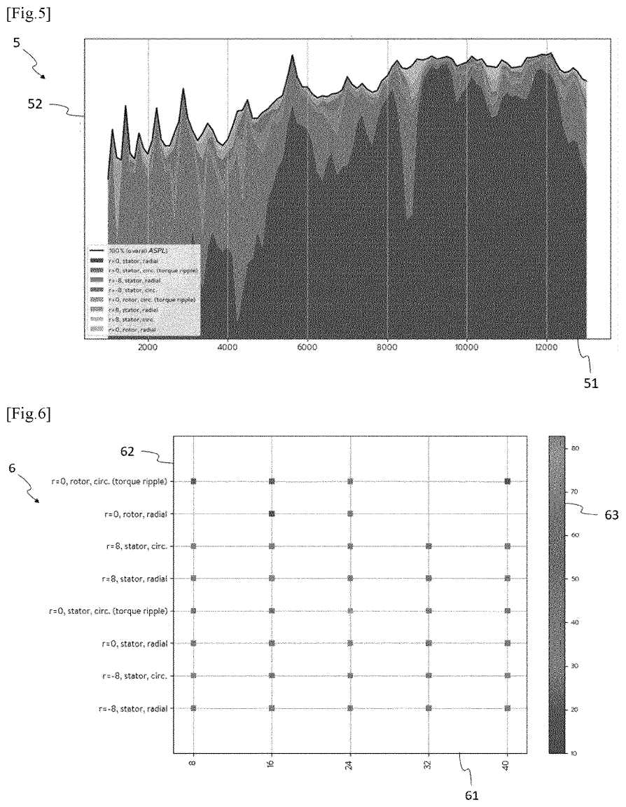

The second graph 5 of FIG. 5 illustrates a separation of the contribution 52, in %, of the different cases of loading at the overall noise level of the machine 1, as a function of the speed of rotation 51, in revolutions per minute. This second graph 5 makes it possible, for example, to determine, for a given speed, which forces are at the origin of the noise, for example, at low speed, the circumferential forces of wave number r=0 on the stator, and at high speed, the radial forces of wave number r=0 on the stator.

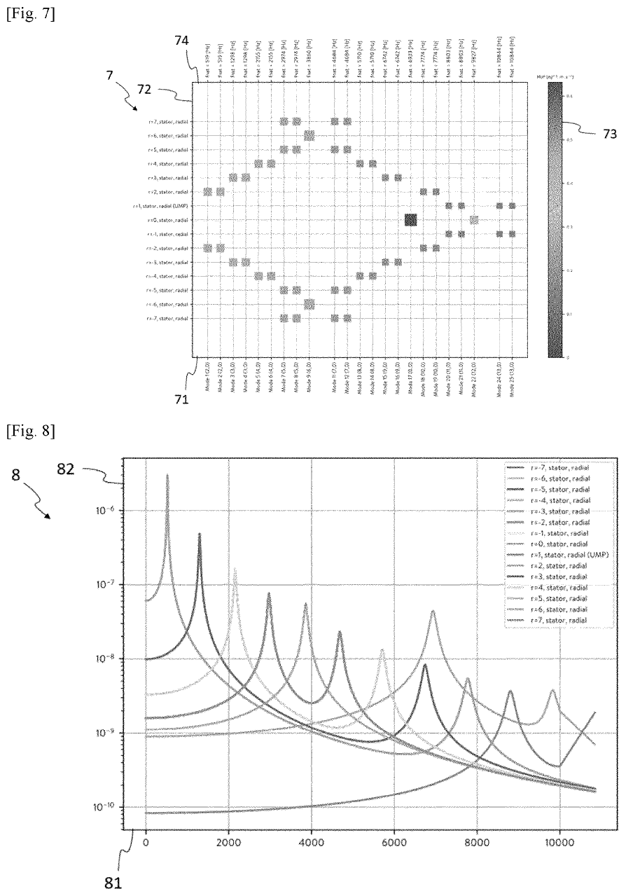

The third graph 6 of FIG. 6 represents another spectrogram illustrating, for a given speed, the acoustic power level 63 as a function of the order of the eigenmodes 61 and of the loading cases 62. This third graph 6 then makes it possible to separate the contribution of the loading cases and of the noise modes of electrical origin.

According to other designs, it is also possible to separate, for example, the contribution of the different radiating surfaces of the machine 1, for example so as to differentiate the radiation from the flanges and the radiation from the cylinder head of the machine 1.

This plurality and this precision in the information transmitted to the user thus makes it possible to understand which type of force excites what type of mode, in order to reduce the vibrations by acting, at the choice, both on the excitation of the machine 1 and on its structure, for example by designing the magnetic circuit differently, the control of the machine, or by moving a natural frequency of the machine 1. It will be understood that this contribution allows work in parallel in the electrical domain and in the mechanical domain, and assists the design teams in these two aspects.

According to one variant, the computer 2 carries out a display of another representative information, for example as a complement or as a replacement for the information representative of the noise and vibration level. The computer displays, for example, a graphic content corresponding to the graphics illustrated in FIGS. 7 and 8.

The fourth graph 7 of FIG. 7 thus illustrates a set of projections between the loading cases 72 and the eigenmodes 71 Each point of the fourth graph 7 thus illustrates, for a combination of a loading case 72 with a specific mode 71, the value of the associated scalar product 73, here in kg^{0.5}·m·s⁻². The points of the fourth graph 7 correspond for example only to the combinations of the subset of cases of loading and of eigenmodes, that is to say to the projections greater than the threshold value employed. Such a fourth graph 7 thus allows a simple visualization of the subset of cases of loading and of significant eigenmodes, as well as, among this subset, the most important combinations. It is for example possible, on the basis of this fourth graph, to adapt the threshold value used to better calibrate the level of detail of the calculations. Advantageously, the fourth graph 7 also illustrates, for each eigenmode 71, the associated natural frequency 74.

The fifth graph 8 of FIG. 8 illustrates the evolution of a set of frequency response functions 82 determined, for example in m/N, as a function of the frequency 81, for example in Hz. This fifth graph 8 thus makes it possible to visualize the vibratory behavior of the machine 1 under the effect of an arbitrarily fixed loading, for example unitary, without taking account of the operating points of the machine 1.

Thus, it will be understood that the present invention provides a method and a device for determining a noise and vibration level of electromagnetic origin of an electric motor machine. This method makes it possible in particular to accelerate and greatly simplify the calculations performed in the field, in particular by comparison with the solutions used in the prior art. This method thus allows the integration of the electromagnetic vibratory analysis in the design phases of electric motor machines, by allowing the results to be obtained within a delay adapted to the time constraints of the domain, without sacrificing the precision.

It will be understood that this determination method can be applied to a variety of electric motor machines, and be integrated into a wider method of electric motor machine design and/or modeling.

It should be observed that this detailed description relates to a particular exemplary embodiment of the present invention, but that in no case this description has any limiting character to the subject matter of the invention; on the contrary, it has the objective of removing any possible inaccuracy or any poor interpretation of the claims that follow.

Of course, the present invention is not limited to the exemplary embodiments described above but extends to a method for determining information representative of noise of electromagnetic origin which would include secondary steps without thereby departing from the scope of the present invention. The same applies to a system and/or to a device configured to implement such a method.

It should also be observed that the reference signs placed between parentheses in the following claims are in no way limiting; these signs have the sole aim of improving the intelligibility and the understanding of the claims which follow as well as the scope of the protection sought.

1. A method for determining a noise and vibration level of electromagnetic origin of an electric motor machine (1) having a mechanical structure, said machine (1) comprising a rotor (11) and a stator (12), said rotor (11) and said stator (12) being separated by an air gap, said method being implemented by at least one processor, said method comprising the following steps:
obtaining (31) first data representative of a set of loading cases associated with said machine (1), each said loading case corresponding to a component of a magnetic loading according to a decomposition on a mathematical basis;
obtaining (32) second data representative of a set of eigenmodes of said mechanical structure;
determining (33), from said set of loading cases and said set of eigenmodes, a subset of loading cases and significant eigenmodes;
obtaining (34) third data representative of a set of relevant nodes associated with said mechanical structure;
computing (35) a set of frequency response functions, by modal expansion restricted to said set of relevant nodes and to said subset of loading cases and significant eigenmodes;
obtaining (36) fourth data representative of a first set of operating points of said machine (1), each said operating point being associated with a torque and a speed of said machine (1);
obtaining (37) fifth data representative of a set of magnetic states of said machine (1), each said magnetic state of said set of magnetic states being associated with an operating point;
determining (38) a set of operational loadings from said set of magnetic states; and
determining (39) information representative of a noise and vibration level of electromagnetic origin of said machine (1) from said set of operational loadings and said set of frequency response functions.

2. The method of claim 1, further comprising displaying, via a human-machine interface, of information belonging to a set of information comprising:
said information representative of said noise and vibration level;
information representative of said subset of loading cases and significant eigenmodes; and
information representative of said set of frequency response functions.

3. The method according to claim 1, further comprising: receiving information representative of a set of magnetic loadings associated with said machine (1), and wherein said obtaining (31) of said first data corresponds to a determination of said set of loading cases associated with said machine (1) from said set of magnetic loadings.

4. The method according to claim 1, further comprising: receiving information representative of said mechanical structure, and wherein said obtaining (32) said second data corresponds to a determination of said set of eigenmodes from said structure.

5. The method according to claim 1, further comprising the steps:
determining a set of projections between said loading cases and said eigenmodes, each said projection of said set of projections being associated with a loading case and an eigenmode; and
comparing each said projection of said set of projections with a threshold value, said subset of loading cases and significant eigenmodes being determined (33) as a function of a result of said comparison.

6. The method according to claim 1 further comprising: determining a set of resonance speeds from said subset of loading cases and significant eigenmodes, each said resonance speed of the set of resonance speeds being associated with an eigenmode of said subset, and wherein said first set of operating points is associated with said set of resonance speeds.

7. The method according to claim 1, further comprising: determining a set of cross projection coefficients between said loading cases, each said cross projection coefficient being associated with a combination of two loading cases of said set of loading cases, said information representative of said noise and vibrations level of electromagnetic origin being determined (39) further as a function of said set of cross projection coefficients.

8. The method according to claim 1, further comprising: obtaining sixth data representative of a set of radiation factors, each said radiation factor being associated with one said eigenmode of said set of eigenmodes, said information representative of said noise and vibration level of electromagnetic origin being determined (39) further as a function of said sixth data.

9. The method according to claim 8, further comprising: receiving information representative of said mechanical structure, and wherein said obtaining of said sixth data corresponds to a determination of said set of radiation factors from said structure.

10. The method according to claim 1, wherein said set of relevant nodes comprises a first subset of nodes to which magnetic forces are applied on said rotor (11) and said stator (12), a second subset of nodes generating acoustic noise radiation, and a third subset of isolated interface nodes.

11. The method according to claim 1, wherein said set of frequency response functions comprises a set of response functions per loading case and optionally per eigenmode of said subset of loading cases and significant eigenmodes, said information representative of said noise and vibration level of electromagnetic origin of said machine (1) being determined (39) separately for each said loading case and optionally for each said eigenmode.

12. The method according to claim 1, wherein said set of frequency response functions comprises a set of acoustic frequency response functions.

13. The method according to claim 1, wherein said set of frequency response functions comprises a set of vibrational frequency response functions.

14. The method according to claim 1, further comprising: receiving information representative of a second set of operating points of said machine (1), and wherein said obtaining (36) said first set of operating points comprises processing said second set of operating points.

15. The method according to claim 1, wherein said set of magnetic states is obtained (37) from said first set of operating points.

16. The method according to claim 1, further comprising: receiving information representative of a selection of a target belonging to a set of targets comprising:
a root mean square vibration of a surface of said machine (1);
a root mean square vibration of at least one node of said machine (1); and
an acoustic power radiated by a part or all of said machine (1), said information representative of said noise level and of vibrations of electromagnetic origin of said machine (1) being determined (39) further as a function of said selection.

17. A computer program fixed in a tangible medium comprising instructions for carrying out the method according to claim 1, when these instructions are executed by a processor.

18. A tangibly fixed computer-readable storage medium on which is recorded a computer program comprising instructions for implementing the steps of the method according to claim 1.

19. A device (2) for determining a noise and vibration level of electromagnetic origin of an electric motor machine, said device (2) comprising a memory (21) associated with at least one processor (20) configured to implement the method according to claim 1.

20. (canceled)
